(19) United States
(12) Patent Application Publication
(10) Pub. No.: US 2020/0315151 A1
(43) Pub. Date: Oct. 8, 2020

(54) FISHING LURE WITH TRAUMA COLORATION

(71) Applicant: J. David Garrison, LaFollette, TN (US)

(72) Inventor: J. David Garrison, LaFollette, TN (US)

(21) Appl. No.: 16/376,658

(22) Filed: Apr. 5, 2019

(51) Int. Cl. A01K 85/00; B29C 45/00; B29C 45/14

(52) U.S. Cl. CPC A01K 85/00; B29L 2031/7002; B29C 45/14008; B29C 45/0001

(57) ABSTRACT

An artificial fishing lure, and a method of constructing the same, the fishing lure including a translucent polymer body, and a separately formed insert member at least partially embedded in the polymer body, the insert member being less translucent that the polymer body and formed to mimic a physical trauma in the fishing lure.

### CROSS-REFERENCE TO RELATED APPLICATIONS

Not applicable.

### FIELD OF INVENTION

The present general inventive concept relates to an artificial fishing lure, and, more particularly, to an artificial fishing lure having trauma marking to lure predator fish.

### BACKGROUND

Fishing is a popular pastime for people of all ages, and many fisherman enjoy the convenience of using artificial fishing lures. There are large varieties of different artificial fishing lures, which vary in size, shape, color, etc., such that fishermen have a large variety of lures to choose from for different waters, areas, target fish, etc. Often, predator fish are attracted to smaller fish that exhibit some sort of distress or injury, as they may be easier to catch that their healthier or more robust counterparts. Thus, an artificial fishing lure designed to resemble a distressed baitfish would be desirable.

### BRIEF SUMMARY

According to various example embodiments of the present general inventive concept, an artificial fishing lure is formed to have an internal coloration that mimics physical trauma or distress in the fishing lure.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a fishing lure including a translucent polymer body, and a separately formed insert member at least partially embedded in the polymer body, the insert member being less translucent that the polymer body

The foregoing and/or other aspects and advantages of the present general inventive concept may also be achieved by providing a method of forming a fishing lure, the method including providing a mold configured to form the fishing lure, forming an insert member configured to be at least partially embedded in the fishing lure, placing the insert member in the mold, placing at least a partially liquified polymer in the mold to form a translucent polymer body, the polymer being configured to be more translucent than the insert member, and allowing the at least partially liquified polymer to harden.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIGS. 1-3 illustrate an artificial fishing lure according to an example embodiment of the present general inventive concept;

FIG. 4 illustrates the artificial fishing lure of FIGS. 1-3 being used with a jig head;

FIG. 5 illustrates a method of forming an artificial fishing lure according to an example embodiment of the present general inventive concept; and

FIG. 6 is a flow chart illustrating various operations in a method of forming an artificial fishing lure according to an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, an artificial fishing lure is provided that resembles an injured or otherwise distressed baitfish. Baitfish that show such trauma are often more eye-catching to predator fish, which improves the chances of a fisherman utilizing the “injured” fishing lure to catch fish. Various example embodiments of the present general inventive concept provide an artificial fishing lure, and a method of constructing the same, the fishing lure including a translucent polymer body, and a separately formed insert member at least partially embedded in the polymer body, the insert member being less translucent that the polymer body and formed to mimic a physical trauma in the fishing lure. Such an embedded insert member being able to be seen “inside” the lure is much more realistic than simply coloring an outer surface of a lure.

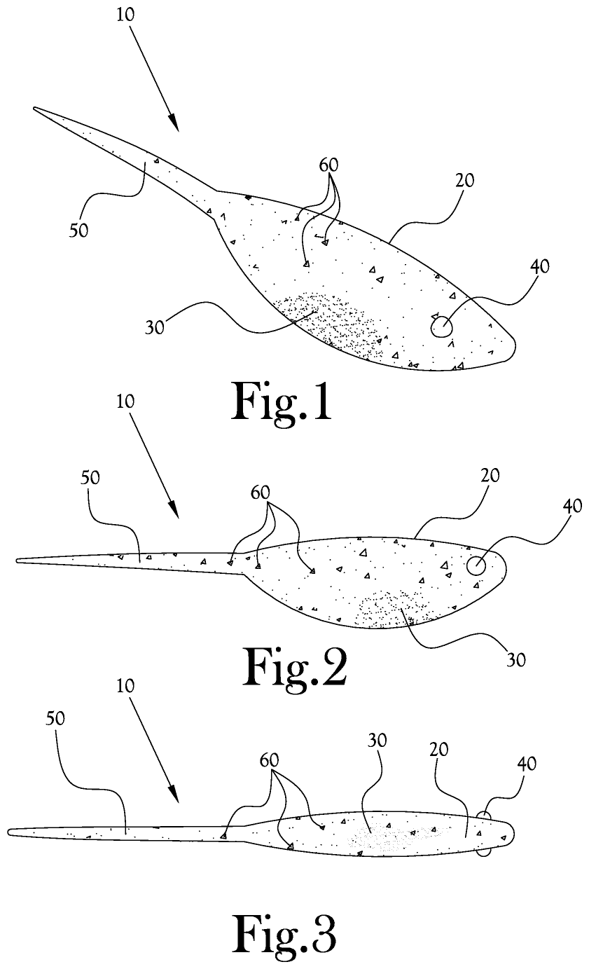

FIGS. 1-3 illustrate an artificial fishing lure according to an example embodiment of the present general inventive concept. In the example embodiment illustrated in FIGS. 1-3, an artificial fishing lure 10 includes a polymer body 20 that is formed to be at least partially translucent, and a separately formed insert member 30 that is formed to be less translucent than the polymer body 20. The insert member 30 is formed so as to appear as an internal trauma in the polymer body, such as a bruise from being bitten, and so forth, or simply some imperfection that may cause the baitfish to be distressed. In various example embodiments, the separately formed insert member 30 may be completely embedded in the polymer body 20, and in other example embodiments a portion of the insert member 30 may partially form the surface of the polymer body 20. In various example embodiments the insert member 30 may be opaque. The insert member 30 may be have a darker color than the polymer body 20. In various example embodiments the polymer body 20 may have only one or more certain portions that are at least partially translucent adjacent the insert member 30, while other portions may be opaque. The insert member 30 may be colored red, yellow, purple, black, orange, blue, or any combination or sub-combination of these colors to as to be a more visually effective indicator of injury or distress. The insert member 30 may be formed of rubber, or of one or more polymers different than, or the same as, the polymer body 20. The insert member 30 may be formed to be more or less rigid than the polymer body 20 so as to affect the movement thereof in the water. The artificial lure 10 may be configured as a minnow, shad, crappie, etc. In various example embodiments, the polymer body 20 may be substantially clear, and may be injected with reflective particles 60 to be more noticeable to predator fish. In various example embodiments, the insert member 30 may be manufactured from any of a number of plastic or polymer materials, or from hardened organic resins, organic solids, synthetic organic materials, ceramic materials, and similar materials. The insert member 30 may be formed in a variety of shapes to mimic various types of traumas, and may be placed at various areas of the polymer body 20. The polymer body 20 may be configured with varying degrees of flexibility according to the type of baitfish it is formed to resemble. In various example embodiments the lure may have a length of approximately 1.5 to 2 inches to resemble a shad hatchling, with an oval shape and spear-type tail. Various other example embodiments may be configured to resemble mayfly hatchlings.

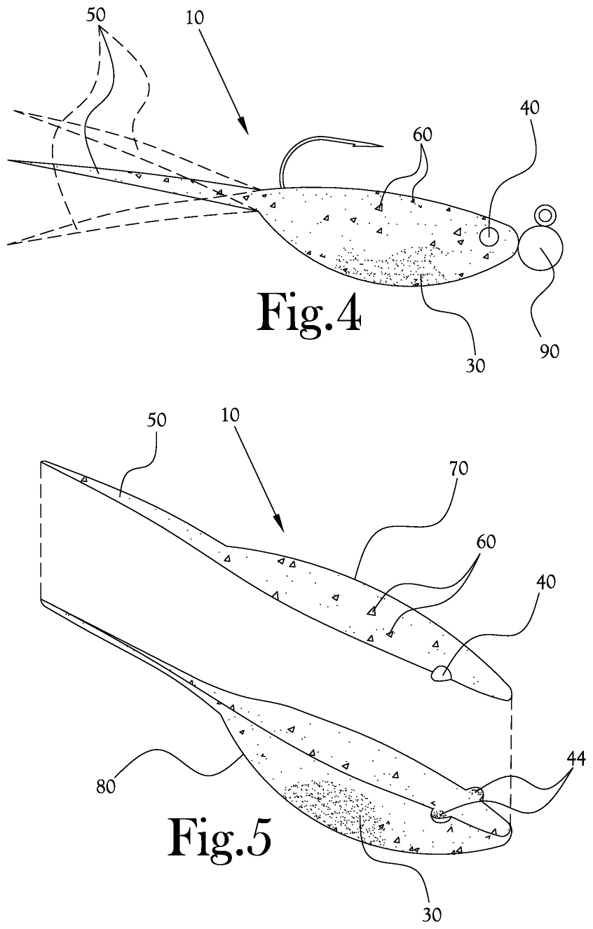

As illustrated in FIGS. 1-3, the lure 10 may include eye portions 40 that extend outward from a head are of the polymer body 20 to enhance the realism of the lure 10. The lure 10 may also include a tail member 50 extending from the rear end of the polymer body 20, and in some example embodiments is configured in a spear-like shape with a length that at least matches the length of the polymer body 20, so as to produce a movement to enhance the realism of the lure 10. FIG. 4 illustrates the artificial fishing lure of FIGS. 1-3 being used with a jig head 90. As illustrated in FIG. 4, the hook extending from the jig head 90 passes through much of the polymer body 20 and extends from a top portion away from the insert member 30, and movement through the water may cause the tail member 50 to move as illustrated. In various example embodiments of the present general inventive concept the jig head 90 may be placed inside the polymer body 20 during the forming of the lure10.

FIG. 5 illustrates a method of forming an artificial fishing lure according to an example embodiment of the present general inventive concept. As illustrated in FIG. 5, a top portion 70 of the lure 10 may be formed separately from the bottom portion 80 of the lure, either by separate molds or by a two-phase operation in a single mold. In this example embodiment, the lure 10 is split such that the top portion 70 has a top portion of the eye portions 40, and the bottom portion 80 has a bottom portion of the eye portions 40. Before joining the top portion 70 to the bottom portion 80 using some type of adhesive substance and/or operation, coloring 44 may be added to the eye portions 40 so that the eye portions 40 take on a more realistic look due to the translucent polymer forming them, which allows the colored “pupils” to be seen inside the eyes. Such coloring may be made simply by a magic marker or similar device, or could be provided by some type of insert in the eye portions 40.

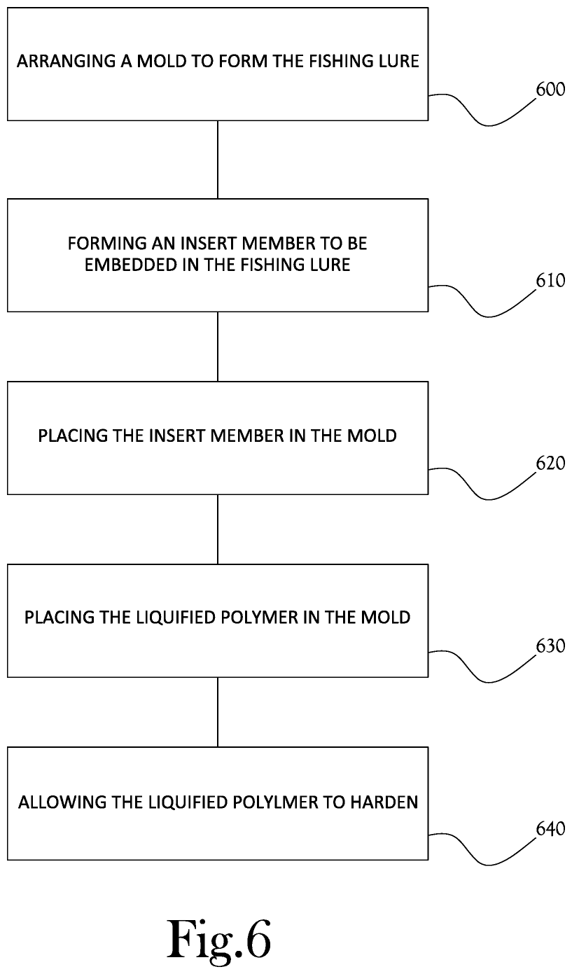

FIG. 6 is a flow chart illustrating various operations in a method of forming an artificial fishing lure according to an example embodiment of the present general inventive concept. It is understood that the illustrated list of operations do not necessarily intend any certain order, and that various example embodiments of the present general inventive concept may include fewer or different operations. In operation 600 a mold is arranged to be used to form the artificial lure. In operation 610 an insert member is formed in any of a host of different shapes and colors to resemble a physical trauma inside the lure. In operation 620 the insert member is placed in the mold, and in operation 630 the liquified polymer used to form the lure is placed in the mold over the insert member. In operation 640 the polymer is allowed to harden, at which point the lure can be removed from the mold. In various example embodiments the insert member can be placed in the liquid polymer material after the liquid polymer has been placed in the mold, or after some of the liquid polymer has been placed therein. The placement of the insert member can be adjusted after the liquid polymer has been poured in the mold. Various example embodiments of the present general inventive concept may include injection molding, pouring melted polymer into the mold, melting the polymer material in the mold, and so on.

Various example embodiments of the present general inventive concept may provide a fishing lure including a translucent polymer body, and a separately formed insert member at least partially embedded in the polymer body, the insert member being less translucent that the polymer body. The insert member may be completely embedded in the polymer body. The insert member may be opaque. The insert member may be configured to appear as internal trauma in the polymer body. The insert member may have a darker color than the polymer body. The insert member may be red, yellow, purple, black, orange, blue, or a combination or sub-combination thereof. The insert member may be configured to be more rigid than the polymer body. The insert member may be formed of a same polymer material as the polymer body. The insert member may be formed of rubber. The fishing lure may further include a tail member extending back from a posterior portion of the polymer body, the tail member being configured in a spear-like shape at least as long as the polymer body. The fishing lure may further include eye portions protruding from opposite sides of an anterior portion of the polymer body, the eye portions having a coloring therein that differs from the polymer body.

Various example embodiments of the present general inventive concept may provide a method of forming a fishing lure, the method including providing a mold configured to form the fishing lure, forming an insert member configured to be at least partially embedded in the fishing lure, placing the insert member in the mold, placing at least a partially liquified polymer in the mold to form a translucent polymer body, the polymer being configured to be more translucent than the insert member, and allowing the at least partially liquified polymer to harden. The method may further include placing the insert member in the mold to correspond to an internal organ location of the fishing lure. The method may further include placing the insert member in the mold after at least a portion of the partially liquified polymer is place in the mold. The method may further include coloring the insert member to have a darker color than the polymer body. The method may further include forming the insert member to be opaque. The method may further include providing a first partial-body mold in which to form a bottom half of the polymer body, providing a second partial-body mold in which to form a top half of the polymer body, placing the insert member in the first partial-body mold, placing the partially liquified polymer into the first and second partial-body molds, allowing the partially liquified polymer to harden, and joining the top and bottom halves of the polymer body together with an adhesive. The top and bottom halves of the polymer body may be configured to bifurcate two eye portions of the polymer body. The method may further include adding color to the eye portions before joining the top and bottom halves of the polymer body. The method may further include mixing reflective particles in the partially liquified polymer

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A fishing lure comprising:
a translucent polymer body; and
a separately formed insert member at least partially embedded in the polymer body, the insert member being less translucent that the polymer body.

2. The fishing lure of claim 1, wherein the insert member is completely embedded in the polymer body.

3. The fishing lure of claim 1, wherein the insert member is opaque.

4. The fishing lure of claim 1, wherein the insert member is configured to appear as internal trauma in the polymer body.

5. The fishing lure of claim 1, wherein the insert member has a darker color than the polymer body.

6. The fishing lure of claim 5, wherein the insert member is red, yellow, purple, black, orange, blue, or a combination or sub-combination thereof.

7. The fishing lure of claim 1, wherein the insert member is configured to be more rigid than the polymer body.

8. The fishing lure of claim 1, wherein the insert member is formed of a same polymer material as the polymer body.

9. The fishing lure of claim 1, wherein the insert member is formed of rubber.

10. The fishing lure of claim 1, further comprising a tail member extending back from a posterior portion of the polymer body, the tail member being configured in a spear-like shape at least as long as the polymer body.

11. The fishing lure of claim 1, further comprising eye portions protruding from opposite sides of an anterior portion of the polymer body, the eye portions having a coloring therein that differs from the polymer body.

12. A method of forming a fishing lure, the method comprising:
providing a mold configured to form the fishing lure;
forming an insert member configured to be at least partially embedded in the fishing lure;
placing the insert member in the mold;
placing at least a partially liquified polymer in the mold to form a translucent polymer body, the polymer being configured to be more translucent than the insert member; and
allowing the at least partially liquified polymer to harden.

13. The method of claim 12, further comprising placing the insert member in the mold to correspond to an internal organ location of the fishing lure.

14. The method of claim 12, further comprising placing the insert member in the mold after at least a portion of the partially liquified polymer is place in the mold.

15. The method of claim 12, further comprising coloring the insert member to have a darker color than the polymer body.

16. The method of claim 12, further comprising forming the insert member to be opaque.

17. The method of claim 12, further comprising:
providing a first partial-body mold in which to form a bottom half of the polymer body;
providing a second partial-body mold in which to form a top half of the polymer body;
placing the insert member in the first partial-body mold;
placing the partially liquified polymer into the first and second partial-body molds;
allowing the partially liquified polymer to harden; and
joining the top and bottom halves of the polymer body together with an adhesive.

18. The method of claim 17, wherein the top and bottom halves of the polymer body are configured to bifurcate two eye portions of the polymer body.

19. The method of claim 19, further comprising adding color to the eye portions before joining the top and bottom halves of the polymer body.

20. The method of claim 12, further comprising mixing reflective particles in the partially liquified polymer.
